(19) United States
(12) Patent Application Publication
(10) Pub. No.: US 2015/0029385 A1
(43) Pub. Date: Jan. 29, 2015

(54) IMAGING LENS SYSTEM AND ELECTRONIC APPARATUS EMPLOYING THE SAME

(71) Applicant: Samsung Electronics Co., Ltd., Suwon-si (KR)

(72) Inventor: Tae-youn Lee, Yongin-si (KR)

(73) Assignee: Samsung Electronics Co., Ltd., Suwon-si (KR)

(21) Appl. No.: 14/107,322

(22) Filed: Dec. 16, 2013

(30) Foreign Application Priority Data
Jul. 25, 2013 (KR) 10-2013-0088244

(51) Int. Cl. G02B 3/04; H04N 5/232

(52) U.S. Cl. CPC G02B 3/04; H04N 5/232
USPC 348/345; 359/708

(57) ABSTRACT

The imaging lens system includes a first lens group and a second lens group that are sequentially arranged from an object side to an image side. The first lens group has a negative refractive power and includes a first lens having an image-side surface concave toward the image side. The second lens group includes a lens that is closest to the object side and an aspheric lens that is closest to the image side. The lens that is closest to the object side has a positive refractive power and an object-side surface convex toward the object side. The aspheric lens that is closest to the image side has a positive or negative refractive power and at least one inflection point on an image-side surface thereof.

### CROSS-REFERENCE TO RELATED PATENT APPLICATIONS

This application claims the priority benefit of Korean Patent Application No. 10-2013-0088244, filed on Jul. 25, 2013, in the Korean Intellectual Property Office, the disclosure of which is incorporated herein in its entirety by reference.

### BACKGROUND

1. Field

One or more embodiments relate to an imaging lens system and an electronic apparatus including the imaging lens system.

2. Description of the Related Art

Recently, digital cameras or video cameras including solid-state imaging devices such as charge coupled devices (CCDs) and complementary metal-oxide semiconductors (CMOSs) have been widely used.

Since imaging apparatuses using solid-state imaging devices are small, recent small information terminals such as cellular phones employ such imaging apparatuses. In addition, an increasing number of customers have gained more knowledge about cameras and demand optical devices that are small, easily correct aberration, and have proper performance such as a wide angle of view and a high magnification according to purposes thereof.

### SUMMARY

One or more embodiments of the invention include a small imaging lens system having a wide angle of view.

Additional aspects will be set forth in part in the description which follows and, in part, will become apparent from the description, or may be learned by practice of the presented embodiments.

According to one or more embodiments, an imaging lens system includes a first lens group and a second lens group that are sequentially arranged from an object side to an image side. The first lens group has a negative refractive power and includes a first lens having an image-side surface concave toward the image side. The second lens group includes a lens that is closest to an object side and an aspheric lens that is closest to an image side. The lens that is closest to the object side has a positive refractive power and an object-side surface convex toward the object side. The aspheric lens that is closest to the image side has a positive or negative refractive power and at least one inflection point on an image-side surface thereof.

The first lens group may be fixed, and the second lens group may be movable along an optical axis of the imaging lens system for focusing.

The second lens group may include a second lens having a positive refractive power and an object-side surface convex toward the object side, a meniscus third lens having a negative refractive power and a convex shape toward the image side, and a fourth lens having a positive or negative refractive power, an image-side surface thereof being an aspheric surface having at least one inflection point. The second to fourth lenses may be sequentially arranged from the object side to the image side.

An aperture stop may be disposed between the first lens and the third lens.

The aperture stop may be disposed on an image-side surface of the second lens.

The aperture stop may be disposed between the first lens and the second lens.

The imaging lens system may satisfy the following condition:

0.3<D1/f<4.0,

where D1 denotes an interval between the first lens and the second lens along the optical axis, and f denotes a focal length of the imaging lens system.

The imaging lens system may satisfy the following conditions:

20<vd3<35,

vd4>50,

where vd3 denotes an Abbe number of the third lens, and vd4 denotes an Abbe number of the fourth lens.

The imaging lens system may satisfy the following condition:

0.7<f/f2<1.5,

where f denotes a focal length of the imaging lens system, and f2 denotes a focal length of the second lens.

The imaging lens system may satisfy the following conditions:

1.58<N3<1.7,

1.51<N4<1.56,

where N3 denotes a refractive index of the third lens at a d-line, and N4 denotes a refractive index of the fourth lens at the d-line.

The imaging lens system may satisfy the following condition:

αᵣ₁>45°,

where αᵣ₁ denotes an angle of a principal ray incident on an object-side surface of the first lens.

The first lens may have a concave or flat object-side surface.

The imaging lens system may satisfy the following condition:

|R1|>10 mm,

where R1 denotes a radius of curvature of an object-side surface of the first lens.

The first lens may be formed of a reinforced plastic material or tempered glass.

An infrared cut-off coating may be formed on an object-side surface of the first lens.

A length of the imaging lens system from an object-side surface of the first lens to the image side may be about 7.5 mm or less.

According to one or more embodiments, an imaging apparatus includes the imaging lens system, and an imaging device that converts optical images formed by the imaging lens system into electric signals.

According to one or more embodiments, an electronic device includes the imaging apparatus.

An object-side surface of the first lens may form a portion of a case or cover of the electronic device.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates an arrangement of an imaging lens system, according to a first embodiment;

FIG. 2A illustrates longitudinal spherical aberration, astigmatic field curves, and distortion of the imaging lens system of FIG. 1 according to the first embodiment;

FIG. 2B illustrates comatic aberration of the imaging lens system of FIG. 1 according to the first embodiment;

FIG. 3 illustrates an arrangement of an imaging lens system, according to a second embodiment;

FIG. 4A illustrates longitudinal spherical aberration, astigmatic field curves, and distortion of the imaging lens system of FIG. 3 according to the second embodiment;

FIG. 4B illustrates comatic aberration of the imaging lens system of FIG. 3 according to the second embodiment;

FIG. 5 illustrates an arrangement of an imaging lens system, according to a third embodiment;

FIG. 6A illustrates longitudinal spherical aberration, astigmatic field curves, and distortion of the imaging lens system of FIG. 5 according to the third embodiment;

FIG. 6B illustrates comatic aberration of the imaging lens system of FIG. 5 according to the third embodiment;

FIG. 7 illustrates an arrangement of an imaging lens system, according to a fourth embodiment;

FIG. 8A illustrates longitudinal spherical aberration, astigmatic field curves, and distortion of the imaging lens system of FIG. 7 according to the fourth embodiment;

FIG. 8B illustrates comatic aberration of the imaging lens system of FIG. 7 according to the fourth embodiment;

FIG. 9 illustrates an arrangement of an imaging lens system, according to a fifth embodiment;

FIG. 10A illustrates longitudinal spherical aberration, astigmatic field curves, and distortion of the imaging lens system of FIG. 9 according to the fifth embodiment;

FIG. 10B illustrates comatic aberration of the imaging lens system of FIG. 9 according to the fifth embodiment;

FIG. 11 illustrates an arrangement of an imaging lens system, according to a sixth embodiment;

FIG. 12A illustrates longitudinal spherical aberration, astigmatic field curves, and distortion of the imaging lens system of FIG. 11 according to the sixth embodiment;

FIG. 12B illustrates comatic aberration of the imaging lens system of FIG. 11 according to the sixth embodiment;

FIG. 13 illustrates an arrangement of an imaging lens system, according to a seventh embodiment;

FIG. 14A illustrates longitudinal spherical aberration, astigmatic field curves, and distortion of the imaging lens system of FIG. 13 according to the seventh embodiment;

FIG. 14B illustrates comatic aberration of the imaging lens system of FIG. 13 according to the seventh embodiment;

FIG. 15 illustrates an arrangement of an imaging lens system, according to an eighth embodiment;

FIG. 16A illustrates longitudinal spherical aberration, astigmatic field curves, and distortion of the imaging lens system of FIG. 15 according to the eighth embodiment;

FIG. 16B illustrates comatic aberration of the imaging lens system of FIG. 15 according to the eighth embodiment;

FIG. 17 illustrates an arrangement of an imaging lens system, according to a ninth embodiment;

FIG. 18A illustrates longitudinal spherical aberration, astigmatic field curves, and distortion of the imaging lens system of FIG. 17 according to the ninth embodiment;

FIG. 18B illustrates comatic aberration of the imaging lens system of FIG. 17 according to the ninth embodiment; and

FIG. 19 illustrates a rear perspective view of a cellular phone including an imaging lens system according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments of the invention will be described below in more detail with reference to the accompanying drawings.

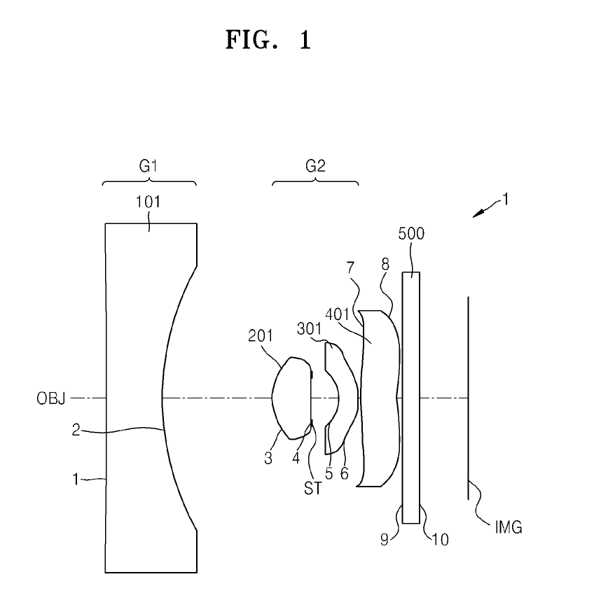

FIGS. 1, 3, 5, 7, 9, 11, 13, 15, and 17 illustrate optical arrangements of imaging lens systems according to first to ninth embodiments, respectively.

Referring to each drawing, an imaging lens system (1 to 9) includes a first lens group G1 and a second lens group G2 that are sequentially arranged from an object side OBJ to an image side IMG. The first lens group G1 has a negative refractive power and includes a first lens (101 to 109) having a concave image-side surface (i.e., concave toward the image side IMG). In the second lens group G2, a lens that is closest to the object side OBJ has a positive refractive power and a convex object-side surface (i.e., convex toward the object side OBJ), and a lens that is closest to the image side IMG has a positive or negative refractive power and an aspheric image-side surface with at least one inflection point.

The first lens group G1 may be fixed, and the second lens group G2 may be movable along an optical axis of the imaging lens system for focusing. This is known as an inner focusing type lens system. In this case, the total length of the imaging lens system does not vary during auto-focusing.

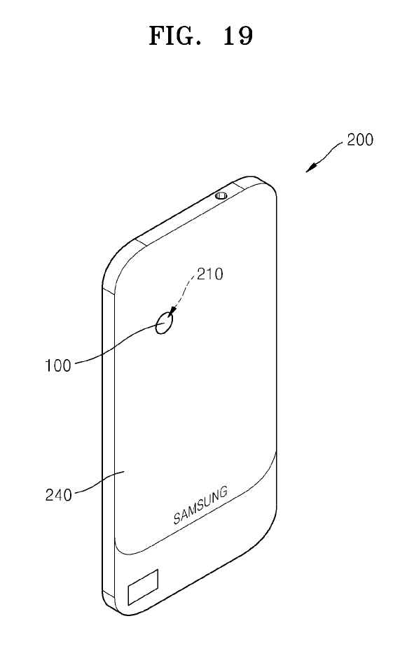

An object-side surface of the first lens (101 to 109) may be concave or flat. The first lens (101 to 109) may be formed of tempered glass or a reinforced plastic material. When the imaging lens system (1 to 9) is used in an electronic device, the object-side surface of the first lens (101 to 109) may function as a cover. This will be described in detail later with reference to FIG. 19. However, the first lens (101 to 109) is not limited thereto. For example, the first lens may be formed of general-purpose glass.

In detail, the second lens group G2 may include: a second lens (201 to 209) having a positive refractive power and a convex object-side surface; a third lens (301 to 309) having a negative refractive power and a meniscus shape convex toward the image side IMG; and a fourth lens (401 to 409) having a positive or negative refractive power and an aspheric image-side surface with at least one inflection point. The second to fourth lenses may be sequentially arranged from the object side OBJ to the image side IMG.

An aperture stop ST may be disposed between the first lens (101 to 109) and the third lens (301 to 309). An infrared cut-off filter 500 may be disposed between the fourth lens (401 to 409) and the image side IMG. An infrared cut-off coating may be formed on the object-side surface of the first lens (101 to 109).

An imaging device (not shown), e.g., a charge coupled device (CCD) or complementary metal-oxide semiconductor (CMOS) imaging device, is disposed on the image side IMG.

The lenses of the imaging lens systems of the embodiments are configured to satisfy demands for easy aberration correction, wide angle-of-view characteristics, and small optical systems.

The imaging lens system (1 to 9) may satisfy the following condition:

0.3<D1/f<4.0 (1)

where D1 denotes the interval between the first lens (101 to 109) and the second lens (201 to 209) along the optical axis of the imaging lens system, and f denotes the focal length of the imaging lens system.

Condition 1 is used to reduce the size of the imaging lens system and correct off-axis aberration of the imaging lens system.

If D1/f is less than the lower limit in condition 1, the axial air gap between the first lens (101 to 109) and the second lens (201 to 209) is small so that the size of the imaging lens system may be reduced, but the angle of light rays incident on the third lens (301 to 309) is excessively large and thus it is difficult to correct off-axial comatic aberration and chromatic aberration of magnification.

If D1/f exceeds the upper limit in condition 1, the axial air gap between the first lens (101 to 109) and the second lens (201 to 209) is large, which increases the total length of the imaging lens system.

The imaging lens system (1 to 9) may satisfy the following conditions:

20<vd3<35 (2)

vd4>50 (3)

where vd3 denotes the Abbe number of the third lens (301 to 309), and vd4 denotes the Abbe number of the fourth lens (401 to 409).

Conditions 2 and 3 regulate the Abbe numbers of the third lens (301 to 309) and the fourth lens (401 to 409) to correct longitudinal axial chromatic aberration.

The imaging lens system (1 to 9) may satisfy the following condition:

0.7<f/f2<1.5 (4)

where f denotes the focal length of the imaging lens system, and f2 denotes the focal length of the second lens (201 to 209).

Condition 4 regulates the refractive power of the second lens (201 to 209) to reduce the total length of the imaging lens system and control the off-axial aberration of the imaging lens system.

If f/f2 is less than the lower limit in condition 4, the refractive power of the second lens (201 to 209) is excessively strong, and thus it is difficult to increase the angle of view of the imaging lens system due to high degrees of spherical aberration, comatic aberration, and astigmatic aberration of the second lens (201 to 209).

If f/f2 exceeds the upper limit in condition 4, the refractive power of the second lens (201 to 209) is weak, and thus the total length of the imaging lens system may be increased.

The imaging lens system (1 to 9) may satisfy the following conditions:

1.58<N3<1.70 (5)

1.51<N4<1.56 (6)

where N3 denotes the refractive index of the third lens (301 to 309) at the d-line, and N4 denotes the refractive index of the fourth lens (401 to 409) at the d-line.

Like conditions 2 and 3, conditions 5 and 6 are used to correct longitudinal chromatic aberration. Here, conditions 5 and 6 regulate the refractive indexes of the third and fourth lenses that satisfy conditions 2 and 3.

The third lens (301 to 309) and the fourth lens (401 to 409) may be formed of a plastic material in aspheric shapes satisfying the above-mentioned conditions, so as to reduce the weight and aberration of the imaging lens system.

The imaging lens system (1 to 9) may satisfy the following condition:

αᵣ₁>45° (7)

where αᵣ₁ denotes the angle of a principal light ray incident on the maximum image height of the object-side surface of the first lens (101 to 109).

Condition 7 is a condition for widening the angle of view of the imaging lens system and reducing the size of the imaging lens system.

The total optical length of the imaging lens system (1 to 9), which is defined from the object-side surface of the first lens (101 to 109) to the image side IMG, may be about 7.5 mm or less.

Hereinafter, lens data will be described according to the various embodiments. In lens data, ST denotes an aperture stop, and “*” following a surface number of a surface denotes that the surface is aspheric. In addition, f denotes the focal length of the imaging lens system, OAL denotes the total optical length of the imaging lens system defined from the object-side surface of the first lens to the image side IMG, Fno denotes an F-number, and 2ω denotes an angle of view. Focal lengths, total optical lengths, radii of curvature, and thicknesses or intervals are given in millimeters (mm).

Aspheric surfaces are defined as follows:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 1 ]$$

where Z denotes a distance measured from the vertex of a lens in the direction of the optical axis of the lens, Y denotes a distance measured from the optical axis in a direction perpendicular to the optical axis, K denotes a conic constant, A, B, C, D, E, and F denote aspheric surface coefficients, and c denotes the reciprocal of the radius of curvature (1/R) at the vertex of the lens.

### First Embodiment

FIG. 1. Illustrates an imaging lens system 1, which includes a first lens group G1 and a second lens group G2 that are arranged in an order from an object side OBJ to an image side IMG. The first lens group G1 includes a first lens 101. The second lens group G2 includes a second lens 201, a third lens 301, and a fourth lens 401. An aperture stop ST is disposed on an image-side surface of the second lens 201.

Lens data of the first embodiment is as follows:

TABLE 1

| | Radii of | Thicknesses or | Refractive | Abbe number |
|---|---|---|---|---|
| | curvature | intervals | index (nd) | (vd) |
| OBJ | infinity | infinity | | |
| 1 | −101.306 | 1 | 1.531 | 55.75 |
| 2* | 4.832 | 1.981 | | |
| 3* | 0.932 | 0.688 | 1.531 | 55.75 |
| 4*(ST) | 11.962 | 0.496 | | |
| 5* | −0.658 | 0.358 | 1.583 | 30.19 |
| 6* | −0.903 | 0.048 | | |
| 7* | 2.756 | 0.647 | 1.531 | 55.75 |
| 8* | 2.468 | 0.1 | | |
| 9 | infinity | 0.3 | 1.517 | 64.2 |
| 10 | infinity | 0.83 | | |
| IMG | infinity | 0.05 | | |

TABLE 2

| Surfaces | K | A | B | C | D | E |
|---|---|---|---|---|---|---|
| 2 | 0.0000E+00 | 1.0869E−03 | 0.0000E+00 | 0.0000E+00 | 0.0000E+00 | |
| 3 | 1.7309E−01 | −7.8575E−02 | 9.4571E−02 | −7.9703E−01 | 1.0502E+00 | −1.5538E+00 |
| 4 | −4.4404E+02 | 5.2619E−02 | −1.4093E+00 | 6.1949E+00 | −1.4516E+01 | 3.4518E−02 |
| 5 | −4.2100E−02 | 1.9121E−01 | −1.9403E+00 | 1.0261E+01 | −3.2702E+01 | 3.4792E+00 |
| 6 | −8.9760E+00 | −1.1691E+00 | 2.6549E+00 | −3.2541E+00 | 3.4964E+00 | −2.0615E+00 |
| 7 | 4.1653E−01 | −4.5760E−01 | 6.0122E−01 | −4.2317E−01 | 1.4926E−01 | −2.1278E−02 |
| 8 | 7.8161E−01 | −2.9604E−01 | 1.6352E−01 | −8.1171E−02 | 2.5842E−02 | −4.2710E−03 |

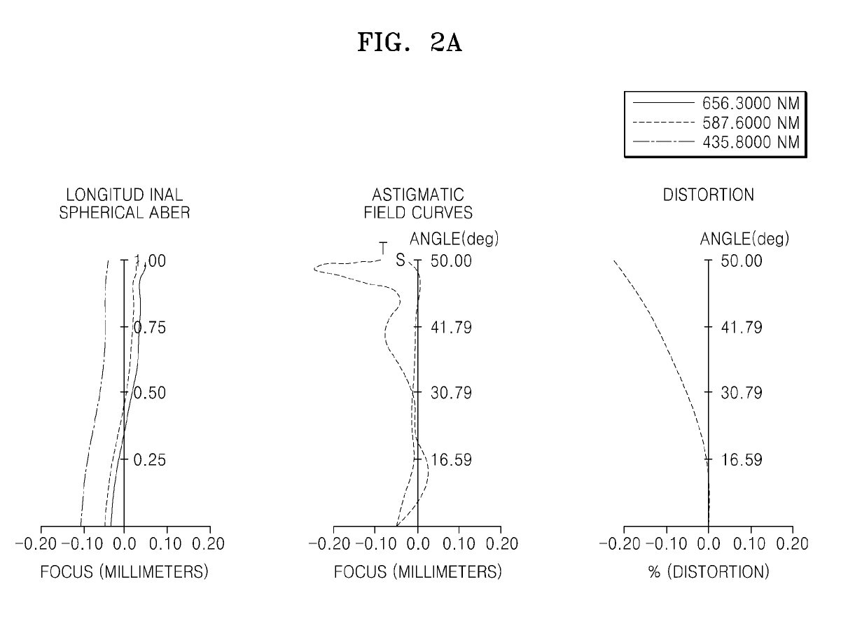

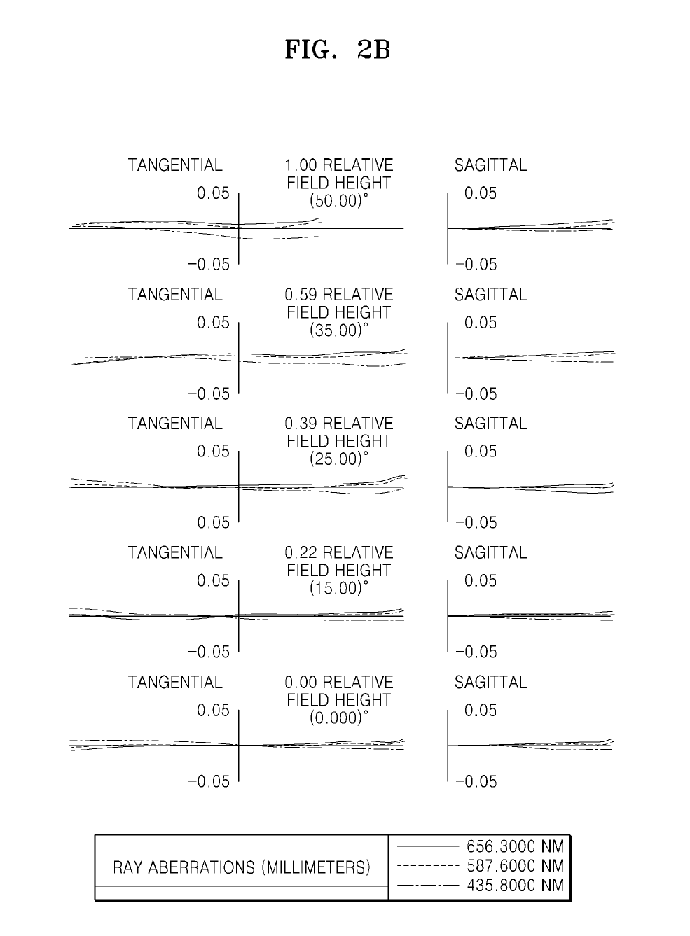

FIG. 2A illustrates longitudinal spherical aberration, astigmatic field curves, and distortion of the imaging lens system 1 of the first embodiment, and FIG. 2B illustrates comatic aberration of the imaging lens system 1 of the first embodiment. In FIG. 2A, longitudinal spherical aberration is plotted with respect to light having wavelengths of 656.30 nm, 587.60 nm, and 435.80 nm, and astigmatic field curves and distortion are plotted with respect to light having a wavelength of 587.60 nm. The astigmatic field curves include a sagittal field curve (S) and a tangential field curve (T).

### Second Embodiment

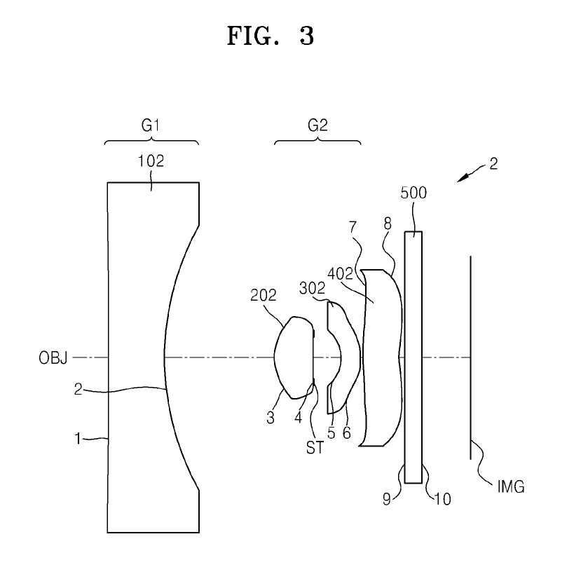

FIG. 3 illustrates an imaging lens system 2, which includes a first lens group G1 and a second lens group G2 that are arranged in an order from an object side OBJ to an image side IMG. The first lens group G1 includes a first lens 102. The second lens group G2 includes a second lens 202, a third lens 302, and a fourth lens 402. An aperture stop ST is disposed on an image-side surface of the second lens 202.

Lens data of the second embodiment is as follows:

TABLE 3

| | Radii of | Thicknesses or | Refractive | Abbe number |
|---|---|---|---|---|
| | curvature | intervals | index (nd) | (vd) |
| OBJ | infinity | infinity | | |
| 1 | −161.516 | 1 | 1.544 | 56.09 |
| 2* | 4.835 | 1.97 | | |
| 3* | 0.946 | 0.75 | 1.531 | 55.75 |
| 4*(ST) | −528.455 | 0.474 | | |
| 5* | −0.62 | 0.35 | 1.636 | 23.9 |
| 6* | −0.908 | 0.049 | | |
| 7* | 2.465 | 0.573 | 1.531 | 55.75 |
| 8* | 2.582 | 0.1 | | |
| 9 | infinity | 0.3 | 1.517 | 64.2 |
| 10 | infinity | 0.863 | | |
| IMG | infinity | 0.03 | | |

TABLE 4

| Surfaces | K | A | B | C | D | E |
|---|---|---|---|---|---|---|
| 2 | 0.0000E+00 | 3.1297E−03 | 0.0000E+00 | 0.0000E+00 | 0.0000E+00 | |
| 3 | 1.5195E−01 | −7.4113E−02 | 6.2784E−02 | −7.9895E−01 | 1.1201E+00 | −1.5538E+00 |
| 4 | −3.9611E+06 | −4.3309E−02 | −1.4479E+00 | 7.0515E+00 | −1.5467E+01 | 3.4518E−02 |
| 5 | −1.3380E−02 | 3.1889E−01 | −2.0586E+00 | 1.1409E+01 | −2.5800E+01 | 3.4792E+00 |
| 6 | −9.0399E+00 | −1.1556E+00 | 2.6477E+00 | −3.2678E+00 | 3.5103E+00 | −1.9818E+00 |
| 7 | −4.1124E−01 | −4.6636E−01 | 5.9839E−01 | −4.2337E−01 | 1.4940E−01 | −2.1121E−02 |
| 8 | 7.5268E−01 | −2.9160E−01 | 1.6396E−01 | −7.9910E−02 | 2.5652E−02 | −4.7011E−03 |

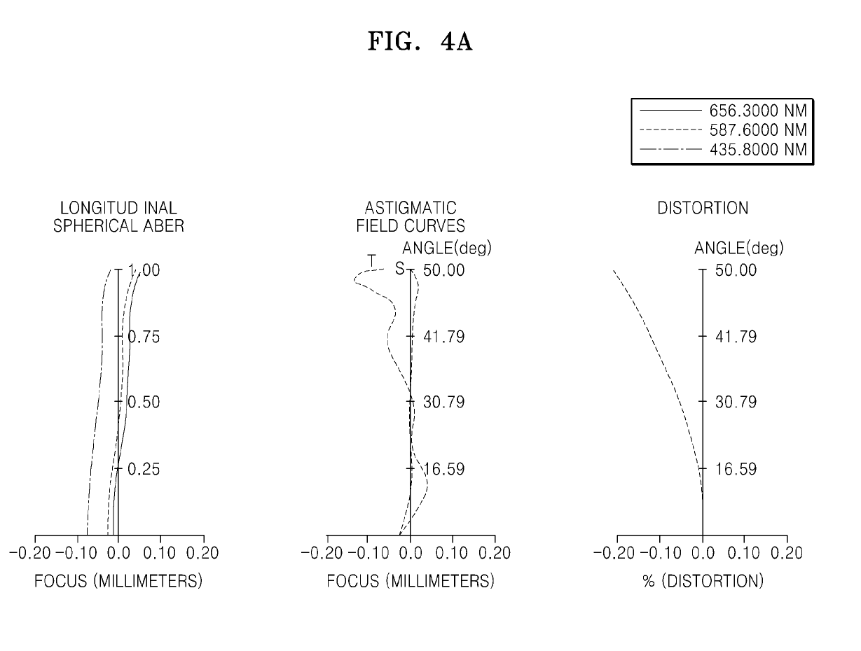

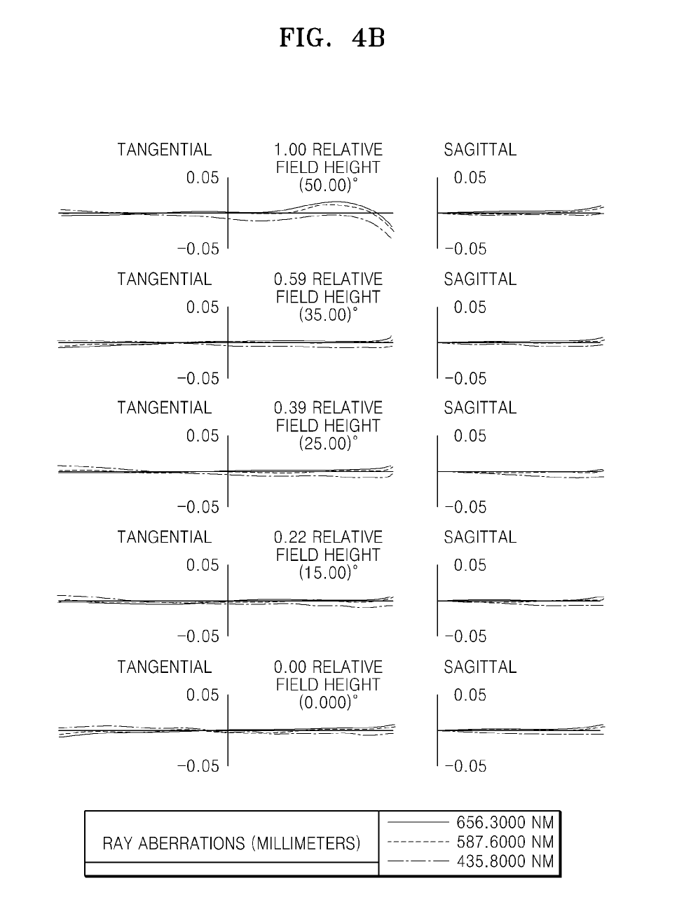

FIG. 4A illustrates longitudinal spherical aberration, astigmatic field curves, and distortion of the imaging lens system 2 of the second embodiment, and FIG. 4B illustrates comatic aberration of the imaging lens system 2 of the second embodiment.

### Third Embodiment

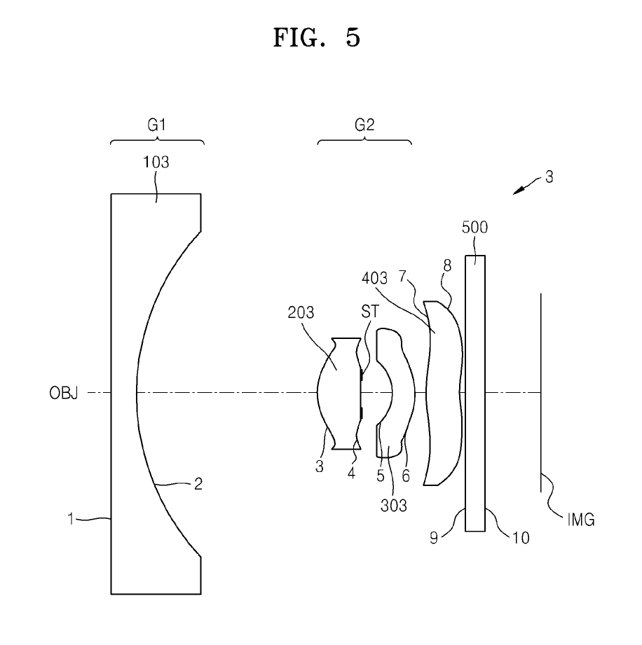

FIG. 5 illustrates an imaging lens system 3, which includes a first lens group G1 and a second lens group G2 that are arranged in an order from an object side OBJ to an image side IMG. The first lens group G1 includes a first lens 103. The second lens group G2 includes a second lens 203, a third lens 303, and a fourth lens 403. An aperture stop ST is disposed on an image-side surface of the second lens 203.

Lens data of the third embodiment is as follows:

TABLE 5

| | Radii of | Thicknesses or | Refractive | Abbe number |
|---|---|---|---|---|
| | curvature | intervals | index (nd) | (vd) |
| OBJ | infinity | infinity | | |
| 1 | infinity | 0.4 | 1.485 | 83.71 |
| 2* | 3.469 | 2.941 | | |
| 3* | 0.963 | 0.65 | 1.524 | 51.83 |
| 4*(ST) | −26.017 | 0.509 | | |
| 5* | −0.642 | 0.35 | 1.636 | 23.9 |
| 6* | −1.121 | 0.2 | | |
| 7* | 1.685 | 0.55 | 1.531 | 55.75 |
| 8* | 3.31 | 0.1 | | |
| 9 | infinity | 0.3 | 1.517 | 64.2 |
| 10 | infinity | 0.894 | | |
| IMG | infinity | 0.01 | | |

TABLE 6

| Surfaces | K | A | B | C | D | E |
|---|---|---|---|---|---|---|
| 2 | 0.0000E+00 | −2.7353E−03 | −3.3477E−04 | 5.5114E−05 | 0.0000E+00 | |
| 3 | 1.0246E−01 | −7.1486E−02 | −2.0666E−02 | −7.6516E−01 | 1.3742E+00 | −2.3410E+00 |
| 4 | 2.1916E+03 | −6.5195E−02 | −1.1990E+00 | 6.9101E+00 | −1.9847E+01 | 3.4518E−02 |
| 5 | 1.5276E−01 | 4.8544E−01 | −1.9910E+00 | 1.3035E+01 | −1.9692E+01 | 3.4792E+00 |
| 6 | −1.3486E+01 | −1.0744E+00 | 2.7016E+00 | −3.2577E+00 | 3.4739E+00 | −2.0203E+00 |
| 7 | −3.7775E+00 | −4.9254E−01 | 5.9924E−01 | −4.2183E−01 | 1.5005E−01 | −2.0823E−02 |
| 8 | 2.7646E+00 | −2.8038E−01 | 1.5693E−01 | −7.8620E−02 | 2.3455E−02 | −4.6718E−03 |

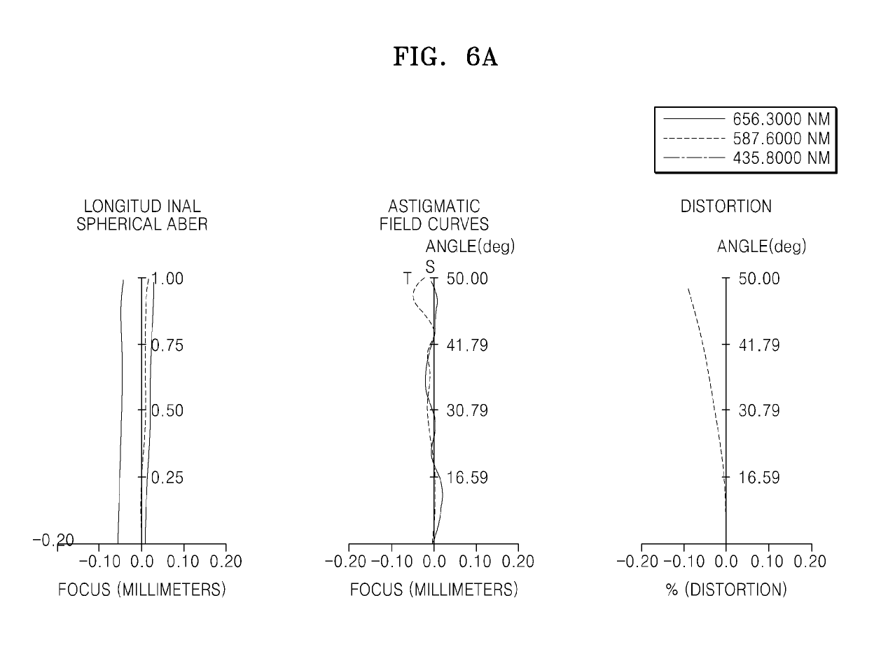

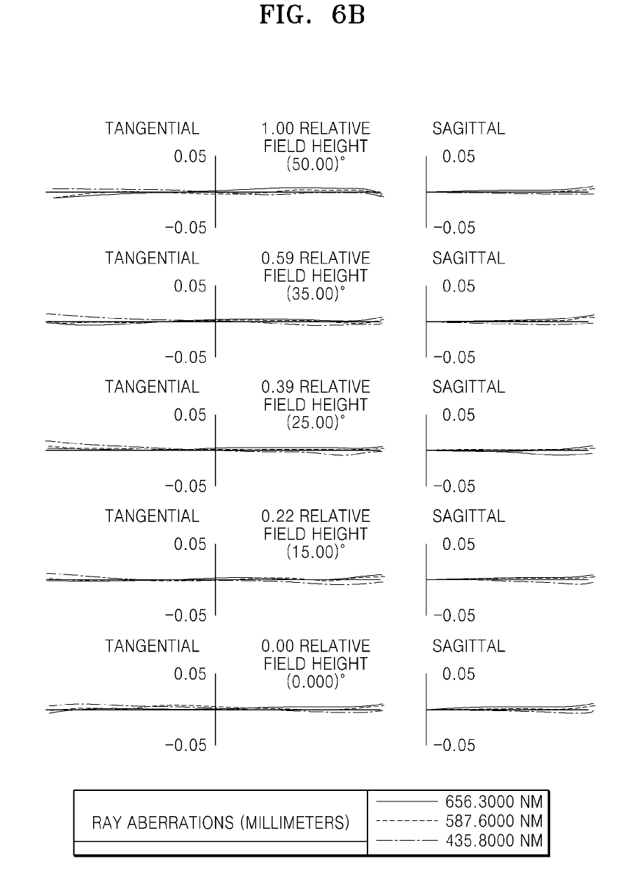

FIG. 6A illustrates longitudinal spherical aberration, astigmatic field curves, and distortion of the imaging lens system 3 of the third embodiment, and FIG. 6B illustrates comatic aberration of the imaging lens system 3 of the third embodiment.

### Fourth Embodiment

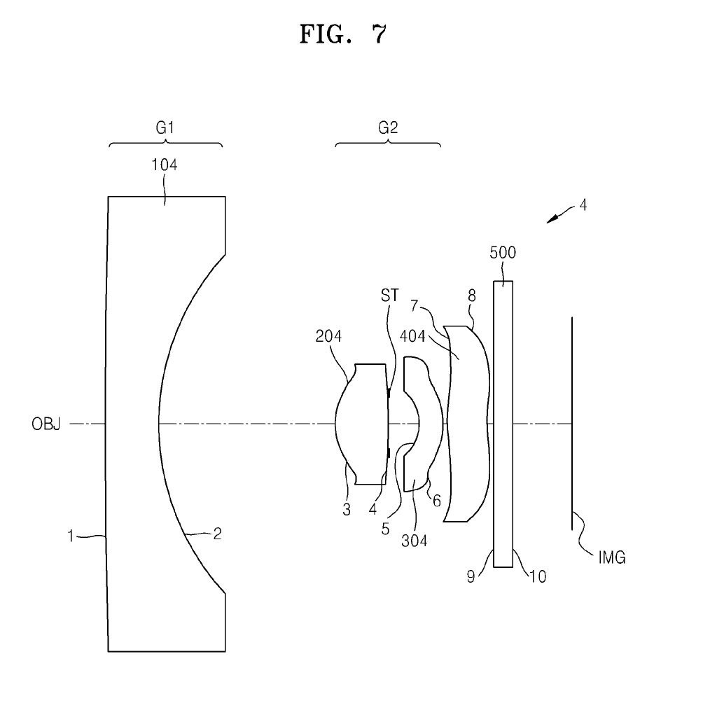

FIG. 7 illustrates an imaging lens system 4, which includes a first lens group G1 and a second lens group G2 that are arranged in an order from an object side OBJ to an image side IMG. The first lens group G1 includes a first lens 104. The second lens group G2 includes a second lens 204, a third lens 304, and a fourth lens 404. An aperture stop ST is disposed on an image-side surface of the second lens 204.

Lens data of the fourth embodiment is as follows:

TABLE 7

| | Radii of | Thicknesses or | Refractive | Abbe number |
|---|---|---|---|---|
| | curvature | intervals | index (nd) | (vd) |
| OBJ | infinity | infinity | | |
| 1* | −600 | 0.8 | 1.485 | 83.71 |
| 2* | 3.538 | 2.727 | | |
| 3* | 0.995 | 0.8 | 1.524 | 51.83 |
| 4*(ST) | −21.005 | 0.478 | | |
| 5* | −0.648 | 0.35 | 1.636 | 23.9 |
| 6* | −0.987 | 0.089 | | |
| 7* | 2.224 | 0.606 | 1.531 | 55.75 |
| 8* | 3.2 | 0.1 | | |
| 9 | infinity | 0.3 | 1.517 | 64.2 |
| 10 | infinity | 0.902 | | |
| IMG | infinity | 0 | | |

TABLE 8

| Surfaces | K | A | B | C | D |
|---|---|---|---|---|---|
| 1 | 0.0000E+00 | 2.7345E−04 | −1.1959E−07 | 0.0000E+00 | 0.0000E+00 |
| 2 | 0.0000E+00 | −1.0546E−03 | −4.3466E−04 | 3.9035E−05 | 0.0000E+00 |
| 3 | 1.2568E−01 | −7.5801E−02 | 3.0210E−02 | −7.5245E−01 | 1.3164E+00 |
| 4 | 1.9808E+03 | −7.0724E−02 | −1.1107E+00 | 7.0198E+00 | −1.7849E+01 |
| 5 | 1.0285E−01 | 5.4777E−01 | −2.3681E+00 | 1.1749E+01 | −1.7554E+01 |
| 6 | −1.1040E+01 | −1.0831E+00 | 2.6669E+00 | −3.2810E+00 | 3.4777E+00 |
| 7 | −1.6852E+00 | −4.7698E−01 | 6.0027E−01 | −4.2295E−01 | 1.4948E−01 |
| 8 | 1.9467E+00 | −2.6429E−01 | 1.4398E−01 | −7.4693E−02 | 2.6785E−02 |

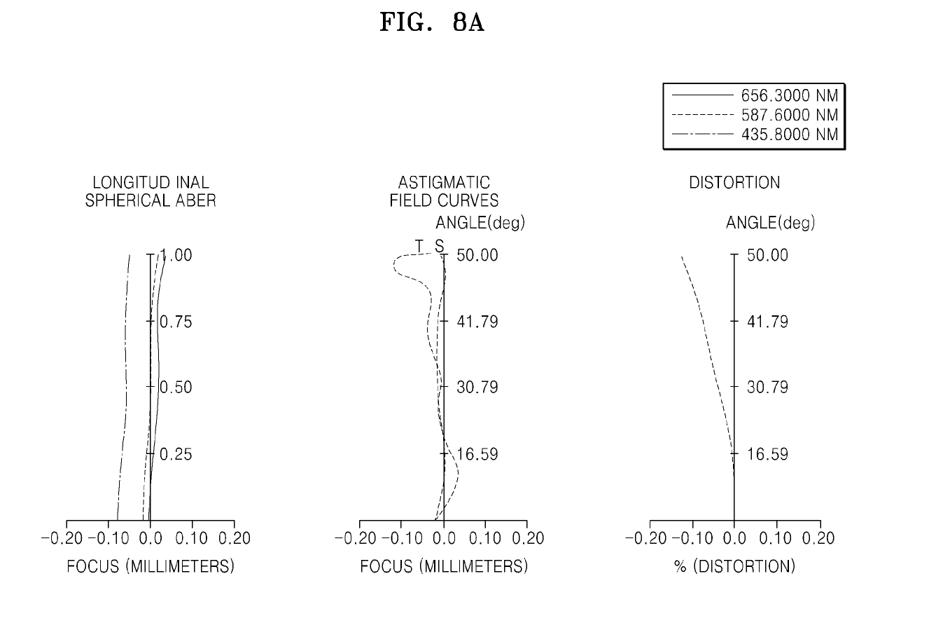

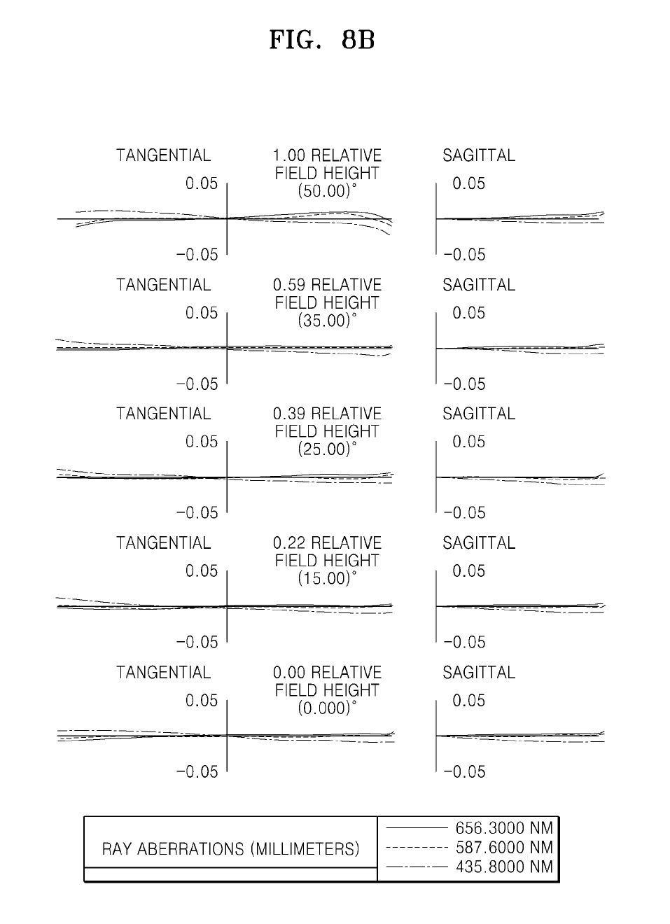

FIG. 8A illustrates longitudinal spherical aberration, astigmatic field curves, and distortion of the imaging lens system 4 of the fourth embodiment, and FIG. 8B illustrates comatic aberration of the imaging lens system 4 of the fourth embodiment.

### Fifth Embodiment

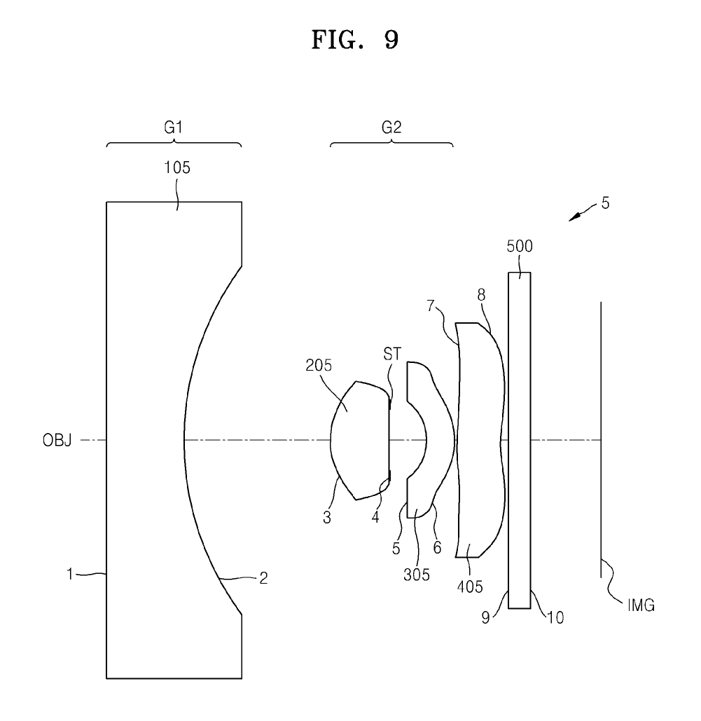

FIG. 9 illustrates an imaging lens system 5, which includes a first lens group G1 and a second lens group G2 that are arranged in a direction from an object side OBJ to an image side IMG. The first lens group G1 includes a first lens 105. The second lens group G2 includes a second lens 205, a third lens 305, and a fourth lens 405. An aperture stop ST is disposed on an image-side surface of the second lens 205.

Lens data of the fifth embodiment is as follows:

TABLE 9

| | Radii of | Thicknesses or | Refractive | Abbe number |
|---|---|---|---|---|
| | curvature | intervals | index (nd) | (vd) |
| OBJ | infinity | infinity | | |
| 1 | −150 | 1 | 1.485 | 69.96 |
| 2* | 3.989 | 1.892 | | |
| 3* | 0.96 | 0.791 | 1.531 | 55.75 |
| 4*(ST) | 63.536 | 0.447 | | |
| 5* | −0.635 | 0.36 | 1.583 | 30.19 |
| 6* | −0.862 | 0.045 | | |
| 7* | 2.735 | 0.574 | 1.531 | 55.75 |
| 8* | 2.484 | 0.1 | | |
| 9 | infinity | 0.3 | 1.517 | 64.2 |
| 10 | infinity | 0.876 | | |
| IMG | infinity | 0.02 | | |

TABLE 10

| Surfaces | K | A | B | C | D | E |
|---|---|---|---|---|---|---|
| 2 | 0.0000E+00 | 1.3838E−03 | 0.0000E+00 | 0.0000E+00 | 0.0000E+00 | |
| 3 | 1.6606E−01 | −7.8849E−02 | 7.0954E−02 | −7.8256E−01 | 1.2222E+00 | −1.5321E+00 |
| 4 | −1.0381E+05 | −1.8833E−02 | −1.4861E+00 | 6.5009E+00 | −1.4120E+01 | 3.4518E−02 |
| 5 | 1.7260E−02 | 2.8898E−01 | −2.0262E+00 | 1.1054E+01 | −2.9767E+01 | 3.4792E+00 |
| 6 | −7.4310E+00 | −1.1568E+00 | 2.6639E+00 | −3.2495E+00 | 3.5139E+00 | −2.0122E+00 |
| 7 | −1.0500E−03 | −4.5852E−01 | 5.9814E−01 | −4.2350E−01 | 1.4928E−01 | −2.1191E−02 |
| 8 | 4.9021E−01 | −3.0890E−01 | 1.6895E−01 | −7.9201E−02 | 2.5513E−02 | −4.7832E−03 |

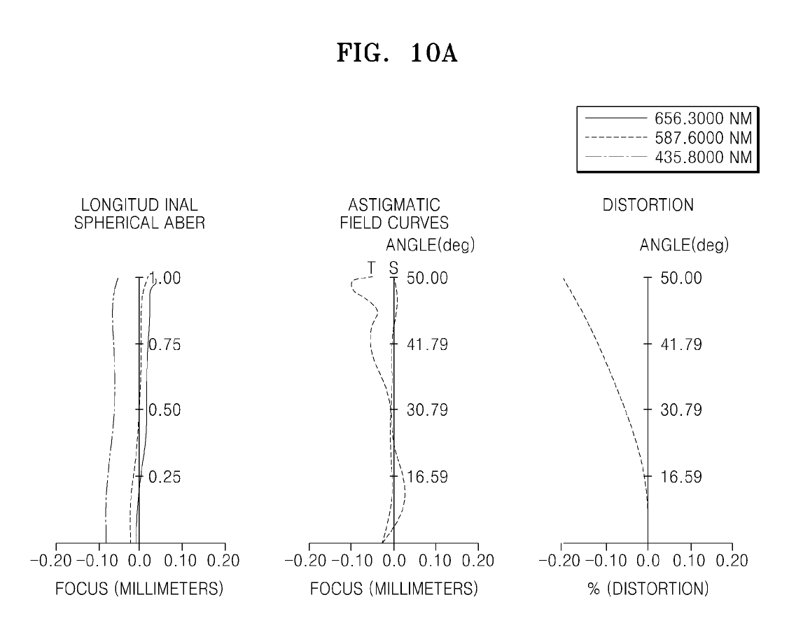

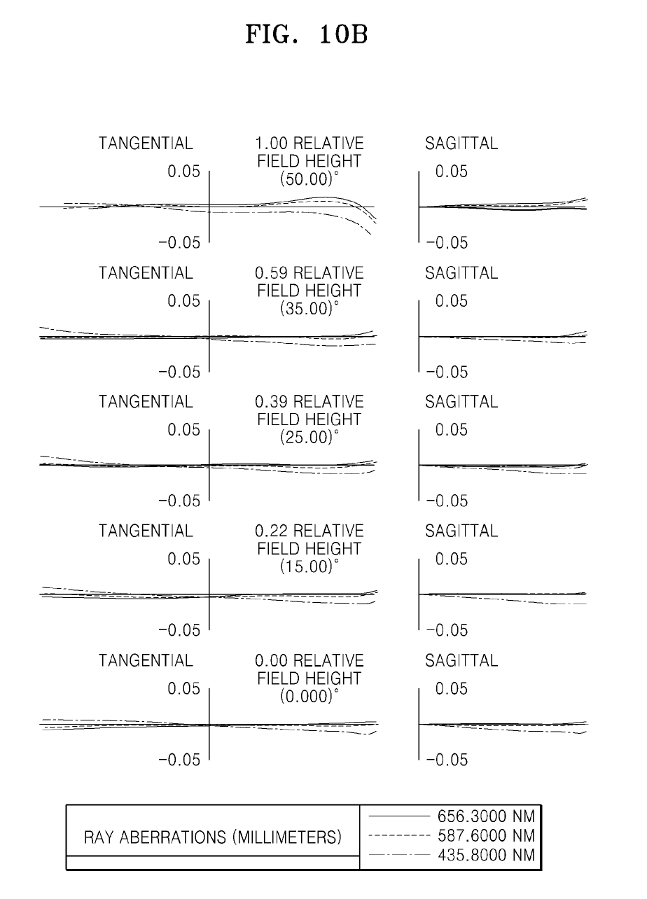

FIG. 10A illustrates longitudinal spherical aberration, astigmatic field curves, and distortion of the imaging lens system 5 of the fifth embodiment, and FIG. 10B illustrates comatic aberration of the imaging lens system 5 of the fifth embodiment.

### Sixth Embodiment

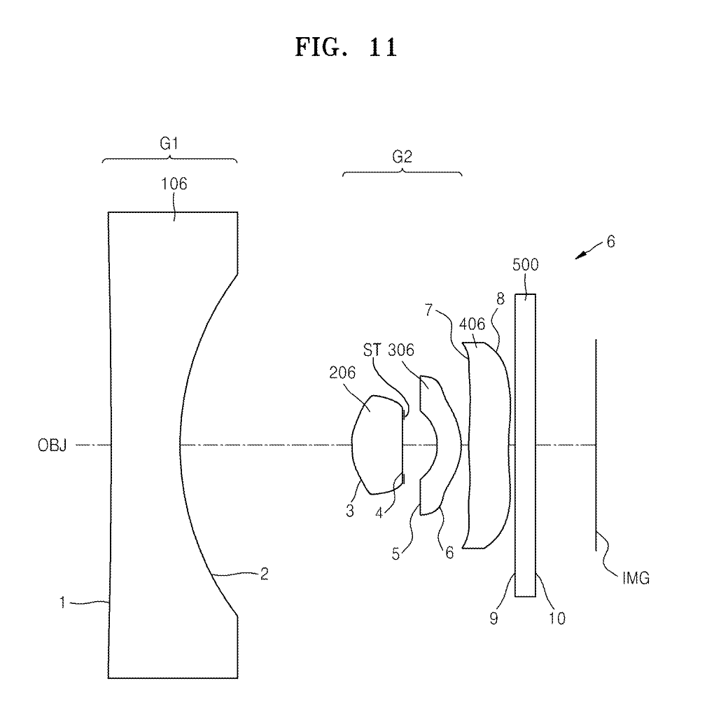

FIG. 11 illustrates an imaging lens system 6, which includes a first lens group G1 and a second lens group G2 that are arranged in an order from an object side OBJ to an image side IMG. The first lens group G1 includes a first lens 106. The second lens group G2 includes a second lens 206, a third lens 306, and a fourth lens 406. An aperture stop ST is disposed on an image-side surface of the second lens 206.

Lens data of the sixth embodiment is as follows:

TABLE 11

| | Radii of | Thicknesses or | Refractive | Abbe number |
|---|---|---|---|---|
| | curvature | intervals | index (nd) | (vd) |
| OBJ | infinity | infinity | | |
| 1 | −150 | 1 | 1.485 | 69.96 |
| 2* | 5.222 | 2.545 | | |
| 3* | 0.988 | 0.769 | 1.544 | 56.09 |
| 4*(ST) | −5.321 | 0.488 | | |
| 5* | −0.611 | 0.35 | 1.651 | 21.53 |
| 6* | −0.921 | 0.108 | | |
| 7* | 3.376 | 0.589 | 1.531 | 55.75 |
| 8* | 3.109 | 0.1 | | |
| 9 | infinity | 0.3 | 1.517 | 64.2 |
| 10 | infinity | 0.403 | | |
| IMG | infinity | 0.5 | | |

TABLE 12

| Surfaces | K | A | B | C | D | E |
|---|---|---|---|---|---|---|
| 2 | 0.0000E+00 | 5.4769E−03 | 0.0000E+00 | 0.0000E+00 | 0.0000E+00 | |
| 3 | 1.6524E−01 | −5.9563E−02 | 2.9513E−02 | −7.5672E−01 | 1.3249E+00 | −1.6815E+00 |
| 4 | −5.8501E+21 | −8.7965E−02 | −1.2238E+00 | 6.8719E+00 | −1.9009E+01 | 3.4518E−02 |
| 5 | 1.0231E−01 | 3.3935E−01 | −2.0272E+00 | 1.1584E+01 | −1.7046E+01 | 3.4792E+00 |
| 6 | −8.6000E+00 | −1.1246E+00 | 2.6280E+00 | −3.3155E+00 | 3.4694E+00 | −1.8864E+00 |
| 7 | 8.8900E−01 | −4.3555E−01 | 5.9287E−01 | −4.2507E−01 | 1.4916E−01 | −2.0989E−02 |
| 8 | 1.2728E+00 | −2.9462E−01 | 1.6648E−01 | −7.8313E−02 | 2.5860E−02 | −5.0175E−03 |

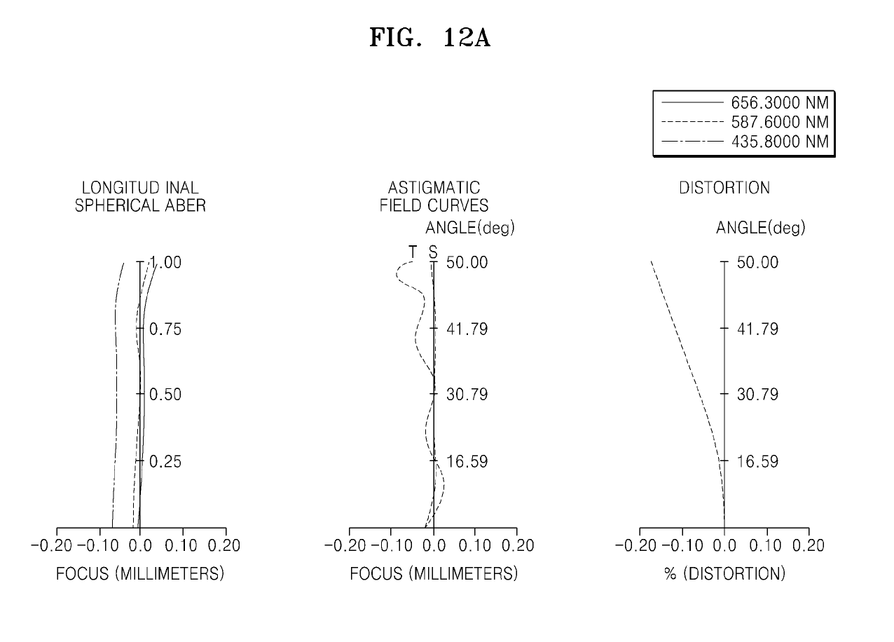

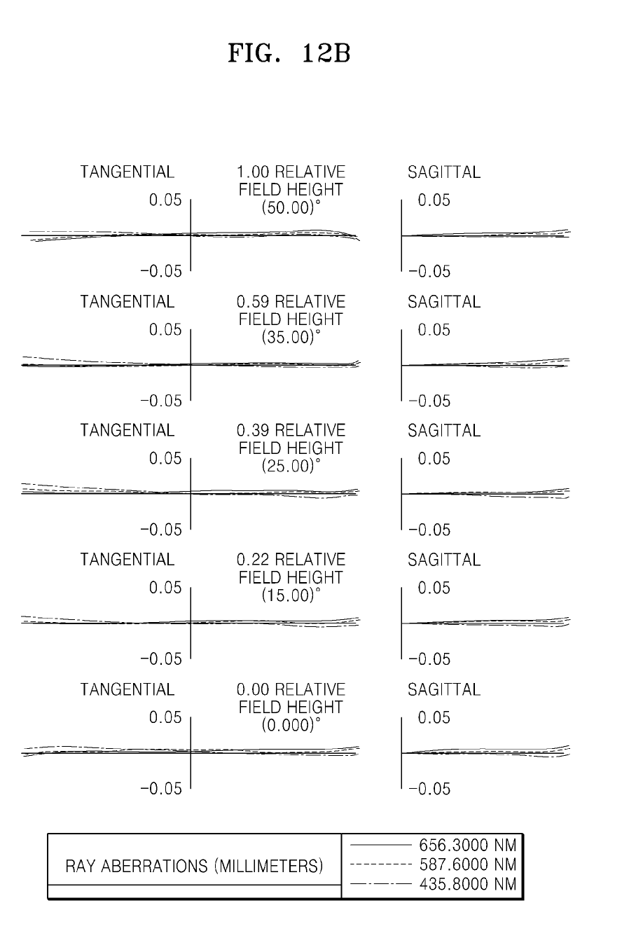

FIG. 12A illustrates longitudinal spherical aberration, astigmatic field curves, and distortion of the imaging lens system 6 of the sixth embodiment, and FIG. 12B illustrates comatic aberration of the imaging lens system 6 of the sixth embodiment.

### Seventh Embodiment

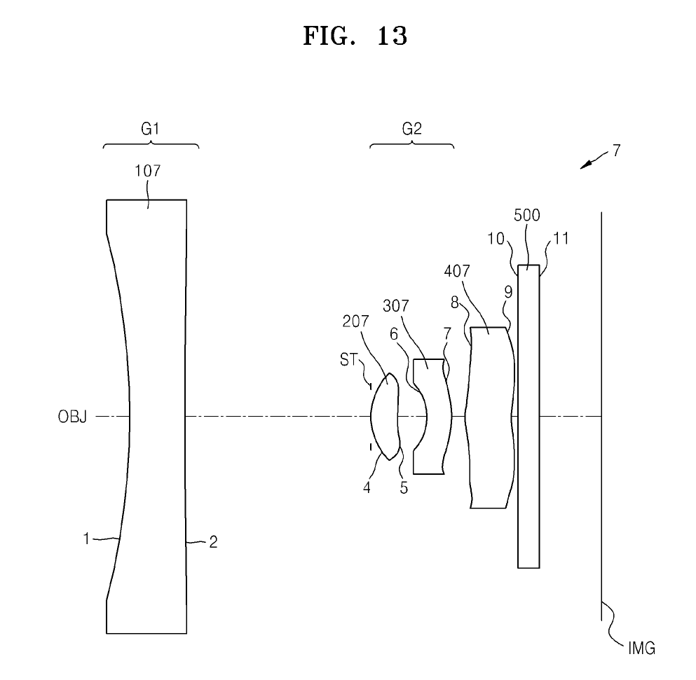

FIG. 13 illustrates an imaging lens system 7, which includes a first lens group G1 and a second lens group G2 that are arranged in an order from an object side OBJ to an image side IMG. The first lens group G1 includes a first lens 107. The second lens group G2 includes a second lens 207, a third lens 307, and a fourth lens 407. An aperture stop ST is disposed between the first lens 107 and the second lens 207.

Lens data of the seventh embodiment is as follows:

TABLE 13

| | Radii of | Thicknesses or | Refractive | Abbe number |
|---|---|---|---|---|
| | curvature | intervals | index (nd) | (vd) |
| OBJ | infinity | infinity | | |
| 1 | −10.599 | 0.8 | 1.531 | 55.75 |
| 2 | 100 | 2.687 | | |
| ST | infinity | 0 | | |
| 4* | 0.86 | 0.394 | 1.531 | 55.75 |
| 5* | 12.752 | 0.409 | | |
| 6* | −0.694 | 0.35 | 1.651 | 21.53 |
| 7* | −1.837 | 0.204 | | |
| 8* | 1.12 | 0.666 | 1.531 | 55.75 |
| 9* | 1.937 | 0.1 | | |
| 10 | infinity | 0.3 | 1.517 | 64.2 |
| 11 | infinity | 0.9 | | |
| IMG | infinity | 0 | | |

TABLE 14

| Surfaces | K | A | B | C | D | E |
|---|---|---|---|---|---|---|
| 4 | −4.1105E−01 | 1.3792E−01 | 1.5895E−01 | −1.2416E+00 | 5.3248E−01 | |
| 5 | 0.0000E+00 | 8.9170E−03 | −2.1309E−01 | 3.1635E−01 | −1.7324E+01 | |
| 6 | 7.4041E−01 | 2.9283E−01 | 7.4765E−01 | 3.0110E+01 | −1.3821E+02 | 1.5083E+02 |
| 7 | 1.4895E+00 | −9.5917E−01 | 3.8092E+00 | −1.0712E+00 | −8.1588E+00 | 8.0289E+00 |
| 8 | −1.2153E+01 | −6.6282E−01 | 1.1357E+00 | −9.6166E−01 | 4.3579E−01 | −8.5520E−02 |
| 9 | −4.0161E−01 | −5.0960E−01 | 4.1846E−01 | −2.6812E−01 | 1.0825E−01 | −1.8654E−02 |

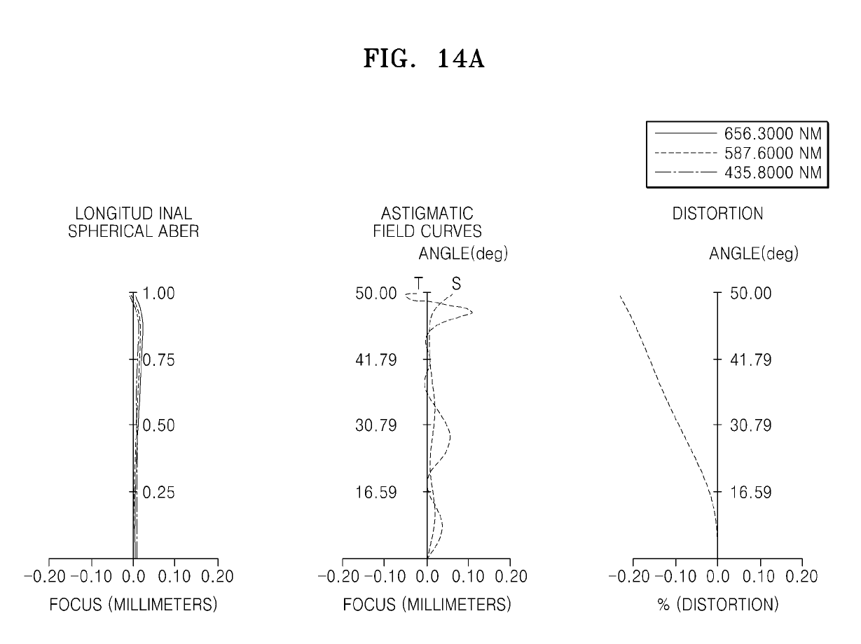

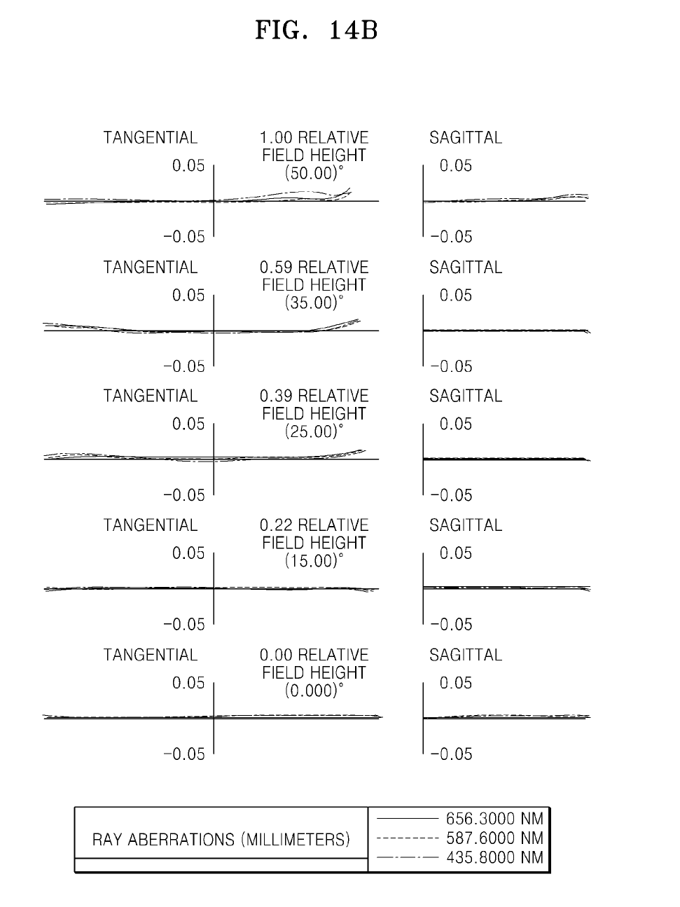

FIG. 14A illustrates longitudinal spherical aberration, astigmatic field curves, and distortion of the imaging lens system 7 of the seventh embodiment, and FIG. 14B illustrates comatic aberration of the imaging lens system 7 of the seventh embodiment.

### Eighth Embodiment

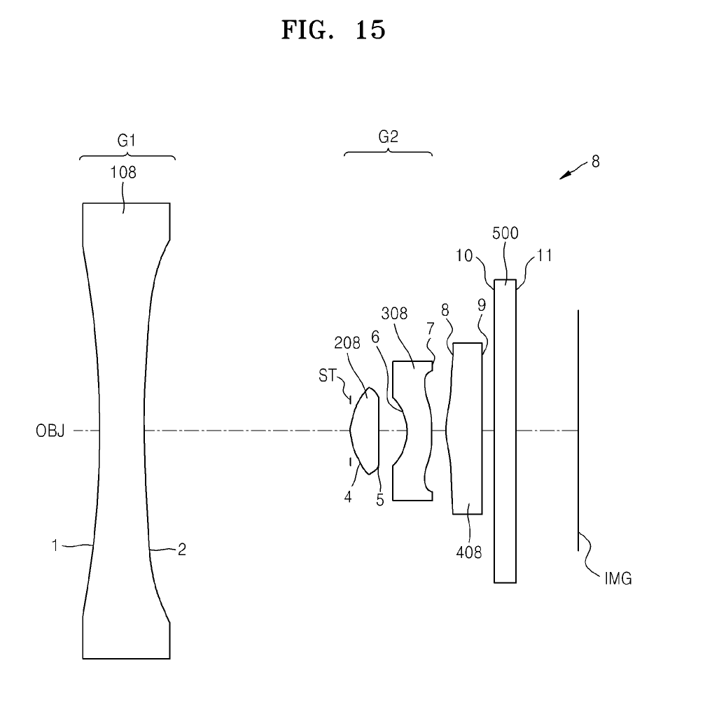

FIG. 15 illustrates an imaging lens system 8, which includes a first lens group G1 and a second lens group G2 that are arranged in an order from an object side OBJ to an image side IMG. The first lens group G1 includes a first lens 108. The second lens group G2 includes a second lens 208, a third lens 308, and a fourth lens 408. An aperture stop ST is disposed between the first lens 108 and the second lens 208.

Lens data of the eighth embodiment is as follows:

TABLE 15

| | Radii of | Thicknesses or | Refractive | Abbe number |
|---|---|---|---|---|
| | curvature | intervals | index (nd) | (vd) |
| OBJ | | | | |
| 1* | −13.408 | 0.663 | 1.544 | 56.09 |
| 2* | 17.845 | 2.973 | | |
| ST | infinity | 0 | | |
| 4* | 0.867 | 0.393 | 1.544 | 56.09 |
| 5* | 15.092 | 0.412 | | |
| 6* | −0.692 | 0.35 | 1.651 | 21.53 |
| 7* | −1.957 | 0.21 | | |
| 8* | 1.102 | 0.6 | 1.544 | 56.09 |
| 9* | 2.417 | 0.1 | | |
| 10 | infinity | 0.3 | 1.517 | 64.2 |
| 11 | infinity | 0.9 | | |
| IMG | infinity | 0 | | |

TABLE 16

| Surfaces | K | A | B | C | D | E |
|---|---|---|---|---|---|---|
| 1 | 0.0000E+00 | 5.5022E−04 | 5.7303E−05 | 0.0000E+00 | 0.0000E+00 | |
| 2 | 0.0000E+00 | −2.2541E−03 | 6.7165E−04 | 0.0000E+00 | 0.0000E+00 | |
| 4 | −4.1105E−01 | 1.3792E−01 | 1.5895E−01 | −4.0073E−01 | −2.6812E+00 | |
| 5 | 0.0000E+00 | 1.9994E−02 | 4.8616E−03 | −1.2243E−01 | −1.6379E+01 | |
| 6 | 7.2740E−01 | 3.6379E−01 | 6.3388E−01 | 2.9994E+01 | −1.3622E+02 | 1.5083E+02 |
| 7 | 1.1877E+00 | −9.3925E−01 | 3.7674E+00 | −1.0993E+00 | −8.1422E+00 | 8.0289E+00 |
| 8 | −1.1362E+01 | −6.6668E−01 | 1.1461E+00 | −9.6387E−01 | 4.2904E−01 | −8.2819E−02 |
| 9 | 3.2241E−01 | −4.7888E−01 | 4.1866E−01 | −2.6685E−01 | 1.0871E−01 | −1.9930E−02 |

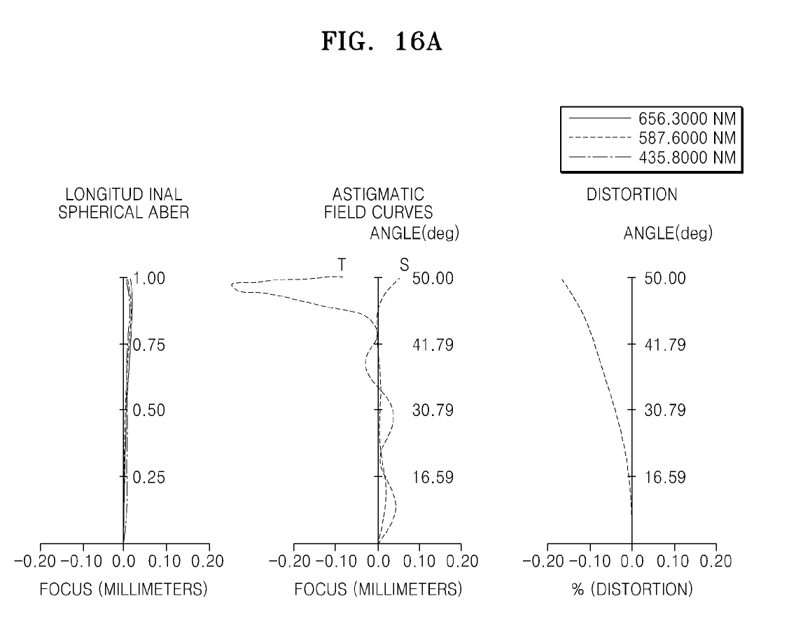

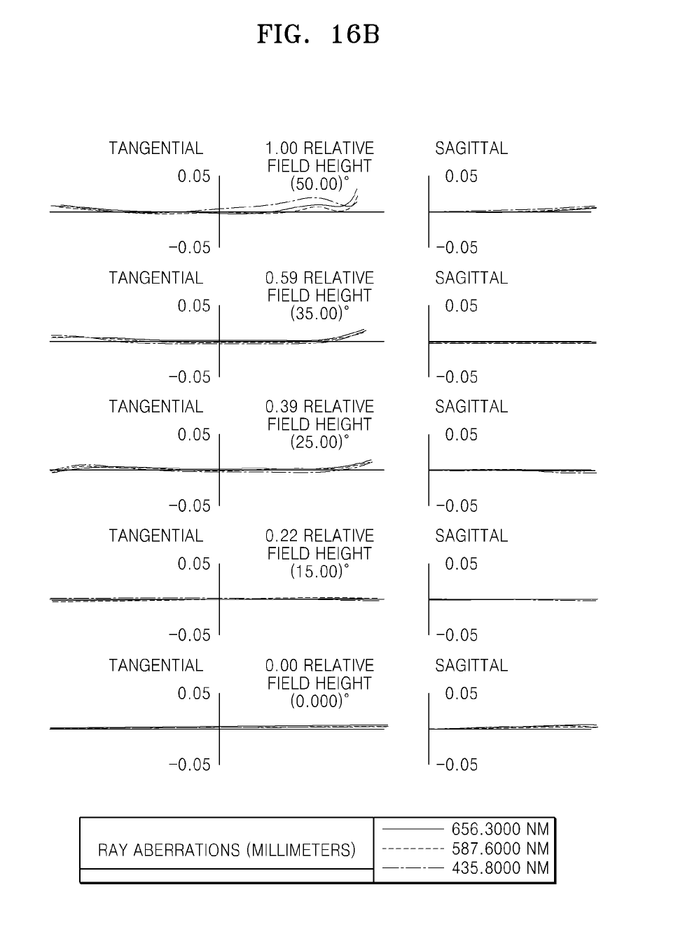

FIG. 16A illustrates longitudinal spherical aberration, astigmatic field curves, and distortion of the imaging lens system 8 of the eighth embodiment, and FIG. 16B illustrates comatic aberration of the imaging lens system 8 of the eighth embodiment.

### Ninth Embodiment

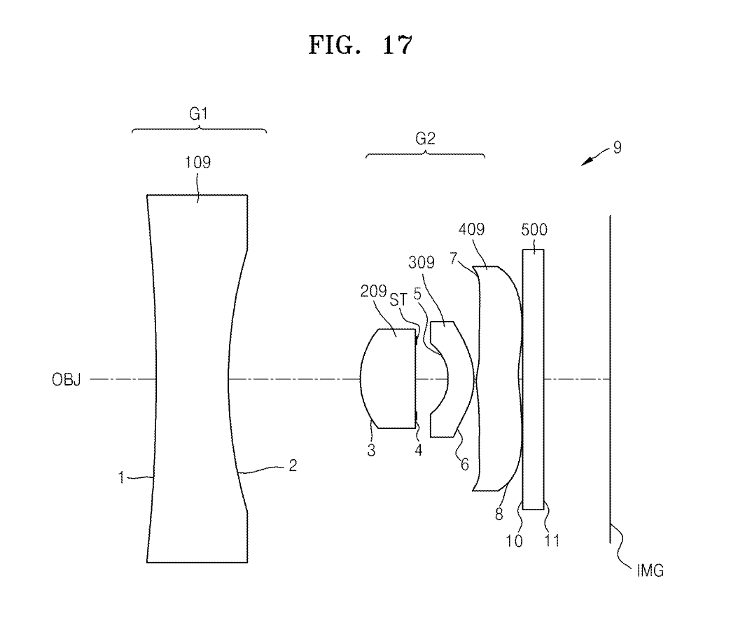

FIG. 17 illustrates an imaging lens system 9, which includes a first lens group G1 and a second lens group G2 that are arranged in an order from an object side OBJ to an image side IMG. The first lens group G1 includes a first lens 109. The second lens group G2 includes a second lens 209, a third lens 309, and a fourth lens 409. An aperture stop ST is disposed on an image-side surface of the second lens 209.

Lens data of the ninth embodiment is as follows:

TABLE 17

| | Radii of | Thicknesses or | Refractive | Abbe number |
|---|---|---|---|---|
| | curvature | intervals | index (nd) | (vd) |
| OBJ | infinity | D0 | | |
| 1 | −29.472 | 1 | 1.531 | 55.75 |
| 2* | 6.648 | D1 | | |
| 3* | 0.952 | 0.765 | 1.531 | 55.75 |
| 4*(ST) | 25.743 | 0.439 | | |
| 5* | −0.643 | 0.355 | 1.583 | 30.19 |
| 6* | −0.882 | 0.045 | | |
| 7* | 2.753 | 0.568 | 1.531 | 55.75 |
| 8* | 2.503 | D2 | | |
| 9 | infinity | 0.3 | 1.517 | 64.2 |
| 10 | infinity | 0.866 | | |
| IMG | infinity | 0.03 | | |

TABLE 18

| Surfaces | K | A | B | C | D | E |
|---|---|---|---|---|---|---|
| 2 | 0.0000E+00 | 1.6854E−03 | 0.0000E+00 | 0.0000E+00 | 0.0000E+00 | |
| 3 | 1.6365E−01 | −7.5335E−02 | 8.4660E−02 | −7.6606E−01 | 1.1677E+00 | −1.5538E+00 |
| 4 | −4.8823E+03 | 8.6344E−03 | −1.5431E+00 | 5.8855E+00 | −9.0977E+00 | 3.4518E−02 |
| 5 | 9.8200E−03 | 2.5527E−01 | −1.9968E+00 | 1.0853E+01 | −3.1841E+01 | 3.4792E+00 |
| 6 | −8.0595E+00 | −1.1545E+00 | 2.6649E+00 | −3.2501E+00 | 3.5105E+00 | −2.0615E+00 |
| 7 | 7.6190E−02 | −4.5862E−01 | 6.0004E−01 | −4.2338E−01 | 1.4926E−01 | −2.1200E−02 |
| 8 | 6.9288E−01 | −3.0123E−01 | 1.6667E−01 | −8.0057E−02 | 2.5597E−02 | −4.5582E−03 |

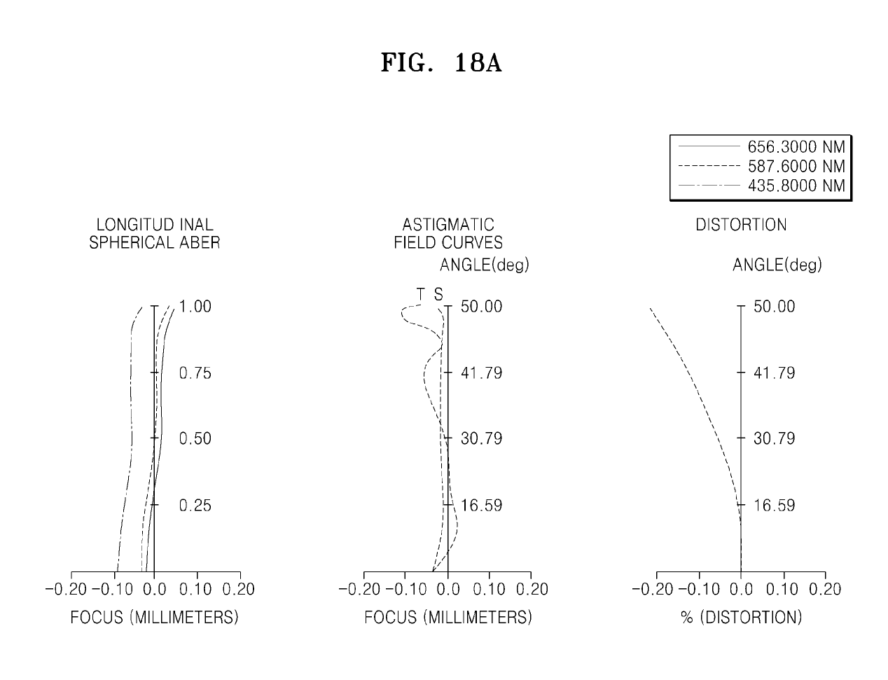

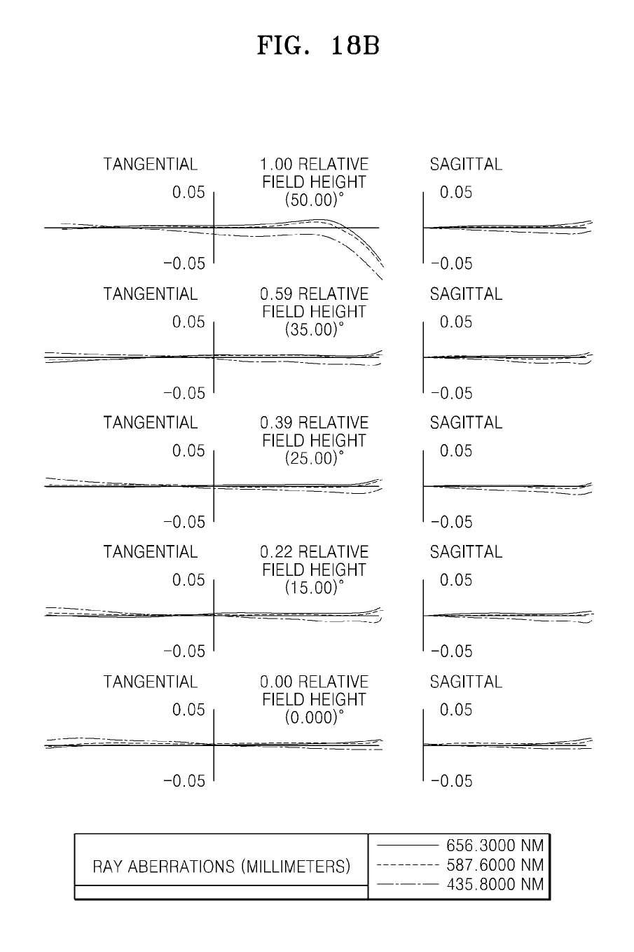

FIG. 18A illustrates longitudinal spherical aberration, astigmatic field curves, and distortion of the imaging lens system 9 of the ninth embodiment, and FIG. 18B illustrates comatic aberration of the imaging lens system 9 of the ninth embodiment.

In Table 19, variable distances that the second lens group G2 is moved during focusing are shown for a first object position Pos1 of infinity and a second object position Pos2 of 300 mm.

TABLE 19

| | Pos1 | Pos2 | |
|---|---|---|---|
| D0 | Infinity | 300 | mm |

| | | | | |
|---|---|---|---|---|
| D1 | 1.78267 | mm | 1.769 | mm |
| D2 | 0.04729 | mm | 0.06095 | mm |

Table 20 below shows total optical lengths (OAL), focal lengths (f), F-numbers (Fno), focal lengths (f1, f2, f3, and f4), and angles of view of the imaging lens systems 1 to 9.

TABLE 20

| | OAL (mm) | f (mm) | Fno | f1 (mm) | f2 (mm) | f3 (mm) | f4 (mm) | 2ω(°) |
|---|---|---|---|---|---|---|---|---|
| E1 | 6.4 | 2.38 | 3.31 | −8.62 | 1.85 | −9.01 | −201.62 | 101.1 |
| E2 | 6.46 | 2.38 | 3.25 | −8.57 | 1.77 | −5.79 | 37.78 | 99.9 |
| E3 | 6.9 | 2.08 | 3.42 | −7.14 | 1.78 | −3.28 | 5.77 | 100.3 |
| E4 | 7.15 | 2.14 | 3.29 | −7.23 | 1.83 | −4.94 | 11.27 | 100.3 |
| E5 | 6.41 | 2.33 | 3.19 | −7.97 | 1.82 | −9.97 | −250.00 | 100.4 |
| E6 | 7.15 | 2.03 | 2.78 | −10.35 | 1.59 | −5.00 | −316.28 | 100.4 |
| E7 | 6.81 | 2.46 | 3.64 | −18.0383 | 1.72 | −1.9507 | 3.90 | 100.4 |
| E8 | 6.9 | 2.24 | 3.26 | −13.9363 | 1.67 | −1.8465 | 3.21 | 100.2 |
| E9 | 6.21 | 2.39 | 3.11 | −10.1160 | 1.84 | −9.0165 | −248.4082 | 100.4 |

E#: embodiment

Table 21 below shows that the imaging lens systems 1 to 9 of the embodiments satisfy conditions 1 to 7.

TABLE 21

| | conditions | | | | | | |
|---|---|---|---|---|---|---|---|
| E# | D1/f | Vd3 | Vd4 | f/f2 | N3 | N4 | αᵣ₁ |
| E1 | 0.83 | 30.19 | 55.75 | 1.28 | 1.583 | 1.531 | 51.3° |
| E2 | 0.83 | 23.9 | 55.75 | 1.34 | 1.636 | 1.531 | 50.8° |
| E3 | 1.41 | 23.9 | 55.75 | 1.17 | 1.636 | 1.531 | 50° |
| E4 | 1.27 | 23.9 | 55.75 | 1.17 | 1.636 | 1.531 | 49.1° |
| E5 | 0.81 | 30.19 | 55.75 | 1.28 | 1.583 | 1.531 | 50.9° |
| E6 | 1.26 | 21.53 | 55.75 | 1.27 | 1.651 | 1.531 | 51° |
| E7 | 1.09 | 21.53 | 55.75 | 1.43 | 1.651 | 1.531 | 62.8° |
| E8 | 1.32 | 21.53 | 56.09 | 1.34 | 1.651 | 1.544 | 57° |
| E9 | 0.75 | 30.19 | 55.75 | 1.2 | 1.583 | 1.53 | 54.4° |

E#: embodiment

According to the embodiments, small and slim imaging lens systems having wide angles of view and high optical performance are provided.

The imaging lens systems of the embodiments may be used in various electronic apparatuses (e.g., image apparatuses) together with imaging devices that convert optical images formed by the imaging lens systems into electric signals. Such imaging apparatuses using the imaging lens systems of the embodiments may be used in various electronic devices or other devices such as portable terminals, intercoms, and automobiles.

FIG. 19 illustrates a rear perspective view of a cellular phone 200 including an imaging lens system according to an embodiment.

An imaging apparatus 210 includes one of the imaging lens systems 1 to 9 and an imaging device, and an object-side surface of a first lens 100 is exposed on the rear side of the cellular phone 200. The first lens 100 may be one of the first lenses 101 to 109. The object-side surface of the first lens 100 forms a portion of a back cover 240. The object-side surface of the first lens 100 may be concave or flat, and the radius of curvature of the object-side surface of the first lens 100 may be greater than 10 mm (i.e., |R1|>10 mm, where R1 is the object-side surface of the first lens 100). Therefore, the first lens 100 may be easily coupled to the back cover 240. The first lens 100 and the back cover 240 are directly coupled to each other so that the object-side surface of the first lens 100 may form a portion of the back cover 240. In this case, additional protection glass is not be disposed between the back cover 240 and the first lens 100, and thus a wide angle of view may be obtained.

The cellular phone 200 illustrated in FIG. 19 is only an example of an electronic apparatus that includes the imaging lens system. That is, the imaging lens systems of the above-described embodiments may be applied to other electronic devices, and the object-side surface of the first lens may form a portion of a cover or case of such electronic devices.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

It should be understood that the exemplary embodiments described therein should be considered in a descriptive sense only and not for purposes of limitation. Descriptions of features or aspects within each embodiment should typically be considered as available for other similar features or aspects in other embodiments. While one or more embodiments of the invention have been described with reference to the figures, it will be understood by those of ordinary skill in the art that various changes in form and details may be made therein without departing from the spirit and scope of the invention as defined by the following claims.

What is claimed is:

1. An imaging lens system comprising:
a first lens group having a negative refractive power, the first lens group comprising a first lens having an image-side surface concave toward an image side; and
a second lens group comprising a lens that is closest to an object side and an aspheric lens that is closest to the image side, the lens that is closest to the object side has a positive refractive power and an object-side surface convex toward the object side, and the aspheric lens that is closest to the image side has a positive or negative refractive power and at least one inflection point on an image-side surface thereof,
wherein the first and second lens groups are sequentially arranged from the object side to the image side.

2. The imaging lens system of claim 1, wherein the first lens group is fixed, and the second lens group is movable along an optical axis for focusing.

3. The imaging lens system of claim 1, wherein the second lens group comprises:
a second lens having a positive refractive power and an object-side surface convex toward the object side;
a meniscus third lens having a negative refractive power and a convex shape toward the image side; and
a fourth lens having a positive or negative refractive power, an image-side surface thereof is an aspheric surface having at least one inflection point,
wherein the second to fourth lenses are sequentially arranged from the object side to the image side.

4. The imaging lens system of claim 3, wherein an aperture stop is disposed between the first lens and the third lens.

5. The imaging lens system of claim 4, wherein the aperture stop is disposed on an image-side surface of the second lens.

6. The imaging lens system of claim 4, wherein the aperture stop is disposed between the first lens and the second lens.

7. The imaging lens system of claim 3, wherein the imaging lens system satisfies the following condition:
0.3<D1/f<4.0,
where D1 denotes an interval between the first lens and the second lens along the optical axis, and f denotes a focal length of the imaging lens system.

8. The imaging lens system of claim 3, wherein the imaging lens system satisfies the following conditions:
20<vd3<35, and
vd4>50,
where vd3 denotes an Abbe number of the third lens, and vd4 denotes an Abbe number of the fourth lens.

9. The imaging lens system of claim 3, wherein the imaging lens system satisfies the following condition:
0.7<f/f2<1.5,
where f denotes a focal length of the imaging lens system, and f2 denotes a focal length of the second lens.

10. The imaging lens system of claim 3, wherein the imaging lens system satisfies the following conditions:
1.58<N3<1.7,
1.51<N4<1.56,
where N3 denotes a refractive index of the third lens at a d-line, and N4 denotes a refractive index of the fourth lens at the d-line.

11. The imaging lens system of claim 1, wherein the imaging lens system satisfies the following conditions:
1.58<N3<1.7,
1.51<N4<1.56,
where N3 denotes a refractive index of the third lens at a d-line, and N4 denotes a refractive index of the fourth lens at the d-line.

12. The imaging lens system of claim 1, wherein the imaging lens system satisfies the following condition:
αᵣ₁>45°,
where αᵣ₁ denotes an angle of a principal ray incident on an object-side surface of the first lens.

13. The imaging lens system of claim 1, wherein the first lens has a concave or flat object-side surface.

14. The imaging lens system of claim 13, wherein the imaging lens system satisfies the following condition:

|R1|>10 mm,
where R1 denotes a radius of curvature of the object-side surface of the first lens.

15. The imaging lens system of claim 1, wherein the first lens is formed of a reinforced plastic material or tempered glass.

16. The imaging lens system of claim 1, wherein an infrared cut-off coating is formed on an object-side surface of the first lens.

17. The imaging lens system of claim 1, wherein a length from an object-side surface of the first lens to the image side is about 7.5 mm or less.

18. An imaging apparatus comprising:
the imaging lens system of claim 1; and
an imaging device that converts optical images formed by the imaging lens system into electric signals.

19. An electronic device comprising the imaging apparatus of claim 18.

20. The electronic device of claim 19, wherein an object-side surface of the first lens forms a portion of a case or cover of the electronic device.
